(19) United States
(12) Patent Application Publication
(10) Pub. No.: US 2022/0248596 A1
(43) Pub. Date: Aug. 11, 2022

(54) AGRICULTURAL SOWING MACHINE WITH A CONVEYOR LINE WITH A VARIABLE LENGTH

(71) Applicant: Lemken Gmbh & Co KG, Alpen (DE)

(72) Inventors: Dennis Bergerfurth, Rees (DE); Christian Gotzen, Viersen (DE)

(21) Appl. No.: 17/622,680

(22) PCT Filed: Jun. 24, 2020
(86) PCT No.: PCT/DE2020/100538

§ 371 Date: Dec. 23, 2021

(30) Foreign Application Priority Data
Jun. 26, 2019 (DE) 10 2019 117 245.4

(51) Int. Cl. A01C 7/20; A01C 7/18

(52) U.S. Cl. CPC A01C 7/205; A01C 7/206; A01C 7/18

(57) ABSTRACT

The present invention relates to an agricultural sowing machine having a machine frame and a plurality of drill units moveably arranged next to one another on the machine frame and seed separating devices, wherein the drill units comprise at least furrow opener, a conveying line for conveying the seeds from the seed separating device to a placement zone with a dispensing opening arranged near the ground and a pressure element, the at least one furrow opener, the dispensing opening and the pressure element being arranged in this operating sequence relative to one another in the drill unit and the seed separating device, without a mechanically rigid connection to a component of a drill unit, is moveably connected to the machine frame.

The present invention relates to an agricultural sowing machine having a machine frame and a plurality of drill units moveably arranged next to one another on the machine frame and seed separating devices, wherein the drill units comprise at least one furrow opener, a conveying line for conveying the seeds from the seed separating device to a placement zone with a dispensing opening arranged near the ground and a pressure element, the at least one furrow opener, the dispensing opening and the pressure element are arranged in this operating sequence relative to one another in the drill unit and the seed separating device being moveably connected to the machine frame without a mechanically rigid connection to a component of a drill unit.

From the publication U.S. Pat. No. 5,603,269 a sowing machine is known, in which the seed separating device is rigidly connected to the machine frame. Since the drill units are moveably fastened to the machine frame, they can follow in the vertical direction irregularities over which they travel during the operation of the sowing machine, and also give way upwards upon contact with a foreign body. Because of the absent coupling to the drill units, the continuous height movements of the drill units are not transferred to the seed separating device. Since they are therefore less shaken by shocks during the operation of the sowing machine, the separating in the seed separating device remains comparatively accurate. However, it has proved to be a disadvantage that the conveying lines have to be formed very long in order to be able to compensate for the movements between the drill units and the seed separating device. The long conveying lines and their movements produce differences in the running distance of the seeds which lead to an inaccurate seed placement. The conveying line is also continuously subjected to deformation which likewise impairs the placement result.

In the publication U.S. Pat. No. 4,074,830 another sowing machine is disclosed, in which the seed separating device is rigidly connected to the drill unit. The conveying line between the seed separating device and the drill unit can be embodied shorter. Through the continuous vertical movements of the associated drill unit however the seed separating device is exposed to continuous shocks and impacts, which lead to errors in the seed separation in the seed separating device and thus defective placement of seed grains in the laid-out seed row.

In the publication WO 2009/043853 A1, generic sowing machines are disclosed in some figures, in which the drill unit and the seed container with the seed separating device fastened thereon are both pivot-moveably connected to the machine frame. The drill unit and the seed container are not coupled to one another by way of a fixed connection, so that they do not move in the same direction and firmly coupled to one another up and down during vertical movements of the drill unit. In these sowing machines the conveying lines are interrupted in sections so that the seed grains are not conducted in these sections. In individual exemplary embodiments, sections of the conveying lines lead into one another without contact and overlapping in the upper region of the conveying line. The positioning of these sections in the upper region of the conveying line is thus accompanied by a major pressure loss in the conveying line even in the acceleration region of the seed grains and air flows directed transversely to the conveying direction of the seed grains through the conveying line, through which the seed grains can be deflected from their optimal transport path and placed inaccurately.

On the whole, the solutions known from the prior art pose the problem that the seed grains exiting the dispensing opening are to be shot as accurately as possible to a point on, to or in front of the pressure element in order to avoid incorrect placements in the seed row. When the seed separating device and the drill unit move relative to one another, the relative position of the conveying line with its dispensing opening changes in relation to the pressure element, resulting in different impact points of the seeds on, to, in front or even next to the pressure element.

The object of the present invention is to improve the seed placement accuracy and reduce the number of defective placements in the spreading of the seeds. Through the more precise separating and placing of the seed grains and through fewer defective placements in the ground the travelling speed of the sowing machine during the sowing is to be increased. The conveying line is to be designed so that it is able to offset the differences in length without increasing the number of defective placements during the placement of the seed grains in the process.

The object is solved for a generic sowing machine in that the telescopable section of the telescopic tubes is situated in the lower half of the conveying line.

With a positioning of the telescopable section of the telescopic tubes in the lower half of the conveying line, the acceleration of the seed grains in the upper section of the conveying line is not impaired. According to a configuration of the invention, the telescopable section of the telescopic tubes can even be situated only in the lower third of the conveying line. The air flowing into the conveying line in the upper region of the same together with the seed grains retains its pressure in this upper conveying section, its flow direction along the course of the conveying line and its moving speed, unchanged. Because of this, the seed grains are subjected to very good acceleration. They also move more accurately along the optimal transport path because they are not deflected in their movement direction by crossing air flows. In the lower half of the conveying line, the seed grains have already reached their maximum movement speed in which they carry within them a comparatively high kinetic energy. With this high kinetic energy, the seed grains can no longer be so easily deflected by interference variables from their optimal transport path along the conveying line. Since the seed grains during a conveying movement through the conveying line are also situated merely for a very short time in the lower half of the conveying line, interference variables can no longer have any significant effect on the actual movement path of the seed grains, so that the seed grains are far less susceptible to interferences in their material flow and their conveying direction in the lower section of the conveying line. Thus, insofar as interferences in the air flow or irregularities in the inner surface of the wall of the conveying line occur in the region of the telescopable section of the telescopic tubes, these hardly have an interfering effect on the movement path of the seed grains in the conveying line any longer.

Through the length-variable formation of the section, the conveying line can nevertheless adapt to the respective current distance between the seed separating device and the drill unit. This is true in particular when a first end of the conveying line is firmly connected to the seed separating device and a second end of the conveying line with a machine component of the drill unit. Through the length-variable design, the conveying line is always at least approximately or exactly only so long as required in each case for connecting the seed separating device with the drill unit, in that it adapts, during vertical movements of the seed separating device and the drill unit, with the length-variable section to the respectively needed length of the conveying line. By adapting the length of the conveying line to a respective dimension just required, in particular when this dimension is shortened, the seed grains conveyed through the same are braked less due to friction, which is why they move with a greater exit velocity out of the dispensing opening and therefore have a shorter dwell time in the conveying line. The shorter conveying line also corresponds rather to the ideal of the direct connection between the seed separating device and the drill unit; while, because of the shorter distance that the seed grains have to cover in the conveying line, the dwell time of the seed grains in the conveying line is also shorter than with longer conveying lines. The reduced friction and the shorter conveying distance produce smaller line-related differences in the placement accuracy of the seed grains.

Since with the configuration of the conveying line according to the invention it is no longer necessary to couple the seed separating device and the drill unit directly and firmly to one another in order to be able to realise short conveying lines, vertical shock movements performed by the drill unit are no longer transmitted to the seed separating device. Vertical shock movements no longer result in that the free cross section of the conveying line changes through folding-in or folding-out wall parts and folding edges either. Such movements in conventional bellows can even stop seed grains completely, which would directly lead to a misplacement of this seed grain. The seed grain separating device can now be operated under favourable operating conditions, which has a positive effect on the separating quality.

The number of the defective placements in the placement of the seed grains is smaller with the length-variable line. The conveying speed of the seed grains conveyed through the conveying line is more homogeneous and exhibits smaller fluctuations between individual seed grains, which makes possible altogether higher conveying speeds. Through the higher conveying speed of the seed grains, these can still be placed sufficiently accurately into the ground even with higher travelling speeds of the sowing machine.

A further advantage of the invention should be seen in that the seed placement through the dispensing opening of the conveying line always takes place in a spatial position, in which the dispensing opening remains in an approximately same position relative to the pressure element. In that the length of the conveying line changes but the spatial position of the dispensing opening always remains the same relative to the pressure element, flight paths of the seeds conveyed through the conveying line that are always the same in relation to the pressure element and thus an approximately constant placement and pressure of the seed in the ground.

Altogether, the effects described above add up to an additional output of the sowing machine. It can be operated with a higher travelling speed and with an increased placement accuracy.

When in the introduction it is mentioned that the seed separating device is moveably arranged on the machine frame this does not mean that the same as only component has to be moveably connected to the machine frame. The seed separating device can also be part of a component group, for example combined with a storage vessel. Then, the component group including the seed separating device is moveably connected to the machine frame together with the seed separating device.

When in the introduction the moveable connection of the drill unit with the machine frame is mentioned this should also be understood in the sense that only individual parts of the drill unit or each part of the drill unit by itself can also be moveably connected to the machine frame.

When in this description a drill unit is mentioned, this need not be mandatorily be formed as a single assembly. The term should be understood to be functional and as collective term for the core components with the machine parts furrow opener, conveying line and pressure element, with which the sowing furrow is torn open and thereafter the seed grains placed into the sowing furrow and pressed on therein. Additional machine parts can be additionally arranged upstream and/or downstream of these core components which perform auxiliary functions such as wheels for height control, smoothing plates or rollers, actuating elements, frame parts, drives and the like. The machine parts belonging to the drill unit can, each by itself, be also connected to the machine frame or a machine part is arranged, by itself, in the sowing machine and the other machine parts form an assembly. The core components of the drill unit can each by itself, partially combined with one another or jointly in a frame, be moveably connected to the machine frame.

A smoothing plate or a comparable machine element, with which the seed shot out of the conveying line is pressed into the ground, has the same effect as and is exchangeable with a pressure element designed as pressure roller. The drill unit can be configured so that the furrow opener and the pressure element are held in a common rigid or moveable frame; however, the furrow opener and the pressure element can also be moveably connected to the machine frame independently of one another, so that these can move independently of one another or be coupled to one another in an articulated manner.

A drill unit can be assigned a single or multiple furrow openers. The furrow openers can be arranged individually or in pairs. The furrow openers can be formed as a fixed coulter or as a rotating disc or double-rotating discs in a V-shaped arrangement pointed arrow-like in the travelling direction.

The angular gap or ventilation openings between the telescopic tubes formed therein can be utilised in order to let compressed air escape from the conveying line in a section situated downstream of the seed separating device, in which the seed grains have already been adequately accelerated by the compressed air, so that the said compressed air does not interfere with the placement of the seed grains in the ground and in the process possibly blows away the seed grains, however without interrupting the conveying of the seeds. The transition of the tube sections can also be utilised specifically by supplying air into the conveying line or by discharging air out of the conveying line, to generate turbulences in the air flow in order to reduce air flow-related placement errors. The flow velocity of the air flowing through the conveying line can also be reduced by a cross-sectional expansion of the conveying line at least also in the region of the transition of the telescopic tubes.

The conveying line is preferably assembled from stiff tube sections, which are formed so as to be telescopable at least in one section. In the case of two telescopable tube sections, these are obviously telescopically moveable only in one section. In the case of more than two sections, which form the conveying line, multiple sections can obviously also be formed in which the tube sections are telescopically moveable into one another. By way of the telescopic tube sections, the length of the conveying line can be changed as required.

According to a configuration of the invention, the furrow opener is formed as one or two disc coulters and the telescopable section of the telescopic tubes is completely situated, from the lateral view of the sowing machine, within the circular circumference of the disc pair or disc pairs or partially protrudes over these. With such a positioning of the telescopable section of the telescopic tubes, these are well shielded by the disc coulter or disc coulters against clods and stones which could otherwise damage and clog-up this section with dirt. Parts of plants remaining on the field cannot so easily snag-up about the conveying line and introduce tension and pending moments in this section of the conveying line, which would render the telescopic movement of the tube sections difficult in this section.

According to a configuration of the invention, a sleeve sealing the telescopic connection is mounted on the outside of the conveying line in the region of the telescopable section of the telescopic tubes. The sleeve can protect the sliding surfaces on the telescopic tubes from dirt so that these are not roughed up by sand grains and become stiff. However, the sleeve can also be embodied so as to be gas-tight so that in the region of the telescopable section of the telescopic tubes no air can escape out of the conveying line to the outside. A pressure loss and turbulences in the air flow within the conveying line are thus avoided in this section. The clearance between the sliding surfaces, along which the telescopic tubes move when being extended or retracted, can then be greater without the flow behaviour of the air flow flowing through the conveying line being disadvantageously changed because of this. In the case of a greater clearance between the sliding surfaces, the telescope is more easily moveable since the friction forces on the sliding surfaces are lower. In order for the sleeve to be able to adapt to changes in length of the conveying line it is possible to provide the same with a bellows in regions.

In a further configuration of the invention, the section comprises at least one interior and exterior part of the telescopic tubes, wherein the exterior part is arranged or plugged on in the conveying direction of the conveying line behind or below the interior part. Because of this, no inner edges project in the conveying direction of the telescopic tubes which deflect or delay the grain transport.

According to a configuration of the invention, the part of the conveying line comprising the telescopable section of the telescopic tubes is connected to a coulter skid. The coulter skid protects the telescopic line colliding with surface soil or stones and plant remnants. In the process, it preferably also decouples the telescopable section of the telescope from bending and sheering forces, which could otherwise act on the same from the soil, stones and other plant remnants. Thus, there is less risk of damage to the conveying line. At the same time, the placement accuracy is increased when the conveying line can perform fewer movements of its own.

According to a configuration of the invention, the coulter skid is moveably connected to the machine frame so that the same can perform movements relative to the same. The relative movements of the coulter skid can be provided in particular in the vertical direction so that the conveying line can also move in the vertical direction. For this purpose, the coulter skid can be directly connected to the furrow opener and/or the machine frame and/or the pressure element by a rigid connecting element or a moveable link arm.

According to a configuration of the invention, a section of the conveying line that follows a curved course adjoins the telescopable section of the telescopic tubes. Because of this, the telescopic movement remains one-dimensional in exactly or at least approximately the vertical direction. The redirecting of the seed grains from a vertical falling and acceleration direction towards the pressure element takes place only after the telescopable section of the telescopic tubes. Because of this, the guiding and movement of the seed grains in this region remains free of interference variables.

According to a configuration of the invention, a change in length of the conveying line results from a section of the conveying line that has been produced from an elastic material, wherein the inner surface of the section produced from an elastic material is in the form of a hose. With a section produced from an elastic material in the form of a hose, the inner surface of this section has no areas which by their shape and orientation exert an interference pulse acting on the seed grains, which move the seed grains out of the general movement path predetermined by the conveying line. In particular rubber or an elastomer plastic can be employed as material for the section produced from an elastic material. This material is sufficiently elastic in order to last without damage a multiplicity of expansions and contractions over the period of use of the sowing machine. An elastic material has the characteristic of the selected material of changing its shape under the effect of force and to return into the original shape when the acting force is no longer present. The elasticity of the elastically formed section of the conveying line should be sufficient in order to offset, cushion and/or dampen the oscillations that occur between the seed separating device and the drill unit during the operation of the sowing machine. This is possible by way of a suitable material and the appropriate dimensioning of the wall thicknesses of the elastic material. In that the inner surface of the section produced from an elastic material does not have any surfaces which, by their shape and orientation, exert an interference pulse acting on the seed grains, which can move the seed grains out of the general movement path predetermined by the conveying line, in particular interferences in the material flow of the seed grains are avoided. The general movement path predetermined by the conveying line is the movement path in which the seed grain moves when it follows the general movement path predetermined by the conveying line. The general movement path is the trajectory which results when the seed grain follows, without particular deflections of the space form, the inner surface of the conveying line as a result of the physical forces such as for example weight, gravity, velocity, friction, flow velocity of the surrounding air, air resistance of the seed grain and the like acting on the seed grain. Here, the trajectory can in individual sections assume a linear or arc-shaped course but it is free of sharp deflections, jumps and offsets.

Surfaces, which divert the movement of the seed grains from the general movement path predetermined by the conveying line, are considered surfaces which exert, by their shape and orientation, an interference pulse acting on the seed grains so that for the seed grain contacting this surface a movement path deviating from the general movement path materialises. The interference pulse can deflect a seed grain in a direction obliquely or transversely to the general movement path, the interference pulse can change the actual movement path in its vertical course or interference pulses of mixed action occur. The interference pulses can occur in particular through material projections in the region of folding edges of bellows or bead edges of rounded transitions of folded material reserves. By way of the interference pulses, the seed grains moved in the conveying line can be braked, they can jump around and then additionally collide once or multiple times with the inner wall of the conveying line resulting in uncontrolled movements or they are subject to a lurching movement. All these path courses deviating from the general movement path bring about that a seed grain moving in such a manner can no longer be precisely placed in the location and in the time cycle in the sowing furrow that would be required for an accurate seed placement.

According to a configuration of the invention, the inner surface of the section produced from an elastic material is not interrupted by material folds and/or corrugations. Material folds and corrugations interfere in particular with the movement of seed grains through a conveying line. The omission of such material folds prevents interferences during a conveying of seed grains through the conveying line.

According to a configuration of the invention, the section produced from an elastic material has a constant cross-sectional shape of the interior over its length. With a constant cross-sectional shape, interfering influences on the movement path of seed grains are avoided.

According to a configuration of the invention, the section produced from an elastic material comprises a transition to the neighbouring regions of the conveying line with its cross-sectional shape of the interior that is at least approximately or precisely offset-free. Component offsets in the transition region can substantially interfere with the passage of seed grains. By way of a transition that is at least approximately or precisely offset-free, such interferences are avoided. A transition that is almost approximately offset-free is to mean a transition where the offset dimension amounts to less than 10% of the diameter of the conveying line.

According to a configuration of the invention, the section produced from an elastic material consists at least partly of a fabric material. The fabric material can have for example a cross-like, net-like or rhomboid weaving pattern. By way of the fabric material, the fatigue strength of the section is improved. Apart from this, the fabric material contributes in keeping the elasticity behaviour of the section at a uniform level over the lifespan.

According to a configuration of the invention, the conveying line is formed flexible at least in one section. The flexible section can correspond to the elastic section, but it can also be formed in particular in a section outside the elastic section. Thus, in the non-elastic section, for example also in a bend of the conveying line, the conveying line can additionally compensate for position changes of the conveying line which result from the change in length of the elastic section.

According to a configuration of the invention, the conveying line is formed so as to be flexible at least in a section within a bending plane which stands parallel to a movement plane of the drill unit to the machine frame. With this configuration, the bending plane thus stands vertically and longitudinally in the travelling direction. In this embodiment, bending thus occurs only in a two-dimensional plane and not in the three-dimensional space. Because of this, the influence of a lateral bending of the conveying line on an out of centre grain placement in the furrow cross-section is diminished or avoided.

According to a configuration of the invention, the section of the conveying line produced from an elastic material is held tensioned at a middle distance of the seed separating device from the drill unit. Thus, the section of the conveying line for example with a maximum elasticity of 50 mm can be pulled apart in a non tensioned state within the limits of the elasticity range in this position of the seed separating device and the drill unit by 25 mm relative to its length. The section produced from an elastic material in this way also serves as a spring/damper element which acts on the movements of the seed separating device. For generating the preload on the hose-shaped section, an energy store can be assigned to the same at least indirectly—directly or by way of a lever arrangement—wherein the same has approximately the same effective spring rate as the hose-shaped section. By way of this a force equilibrium is established which holds the seed separating device in a neutral position, from which it can swing into an upper or lower end position.

In such a preloaded keeping, the inner surfaces of the section of the conveying line are smooth and do not interfere with the material flow through the conveying line. In this way, the air flow, with which the seed grains are conveyed through the conveying line is not unnecessarily swirled up either. Seed grains cannot accumulate in material pockets while passing through the conveying line. Advantageously, the inner cross-section should not have been reduced so far that interferences in the material flow of the seeds occur here.

A further advantage of an elastic material in a section of the conveying line should be seen in that the conveying line in this elastic section extends under preload always straight along the predetermined conveying path. Through the elastic flexing movement of the material during the movements of the seed separating device and of the drill unit, material possibly adhering to the inner wall of the section is also detached so that the elastic section of the conveying line does not so easily get dirty or even clogged.

According to a configuration of the invention, the seed separating device has at least one separating element which meters or separates the seeds by means of pneumatic pressure gradient. The pneumatic pressure gradient is advantageous because it favourably accelerates and distributes the seed grains in the seed separating device. The separating precision with pneumatic systems is very high.

According to a configuration of the invention, the conveying line over its course comprises protrusions and/or recesses on the inner surfaces, which in the wall region generate turbulent flows in the air flow. The turbulent flows in the air flow in the wall region form a kind of air cushion for the seeds conveyed through the conveying line, as a result of which the same slides to a lesser degree over the inner surfaces and because of this is braked to a lesser degree due to friction. A really distributed dimples for example, which generate turbulent flows in a passing air flow, are possible as recesses. Spoiler-type protrusions can also guide the air flow and in turn generate specific turbulences which for the seeds conveyed in the conveying line form a gas cushion.

According to a configuration of the invention, the conveying line is connected to the moveable mounting of the furrow opener on its half facing the ground. A movement of the furrow opener in the vertical direction is transmitted via the connection of the conveying line with the furrow opener onto the conveying line so that with the pivot movement of the furrow opener the conveying line is pulled lengthwise or shortened again. Thus, the length of the conveying line is continuously adapted to the respective length requirement by way of the movement of the furrow opener in the vertical direction.

According to a configuration of the invention, the seed separating device is coupled to the drill unit via a spring and/or damper element. By way of the spring and/or damper element it is possible to reduce force peaks, which during very rapid or greater movements of the seed separating device and of the drill unit can act on the conveying line. Here it should be taken into account that depending on the configuration of the sowing machine, not only the seed separating device is moveably connected to the machine frame, but the seed separating device can only be a component of a component group with for example a storage vessel which—in particular when it is filled—can develop substantial forces when it moves in the vertical direction during the operation of the sowing machine. The drill unit also has a substantial weight which during movements in the vertical direction develops substantial forces which then act on the conveying line. The different amplitudes, with which the seed separating device and the drill unit move for lack of a fixed connection, are advantageously reduced by the spring and/or damper element. This is not only beneficial for the lifespan of the conveying line but also for the operating result of the seed separating device and of the drill unit.

According to a configuration of the invention, the seed separating device is coupled to the machine frame via a spring and/or damper element. The force peaks acting on the conveying line can also be reduced by this measure in that the spring and/or damper element smooth/es the amplitudes with which the seed separating device or the component group, whose constituent part the seed separating device is, moves.

Further features of the invention are obtained from the claims, the figures and the subject description. All features and feature combinations mentioned above in the description and the figure description mentioned in the following and/or features and feature combinations shown alone in the figures cannot only be used in the respective combinations stated but also in other combinations or by themselves provided this is not contradicted by any technical obstacles.

The invention is now explained in more detail by way of a preferred exemplary embodiment and making reference to the enclosed drawings.

It Shows:

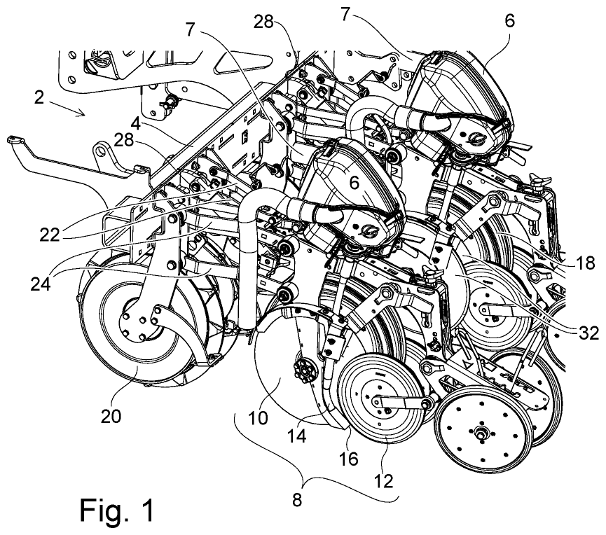

FIG. 1: a view of a sowing machine,

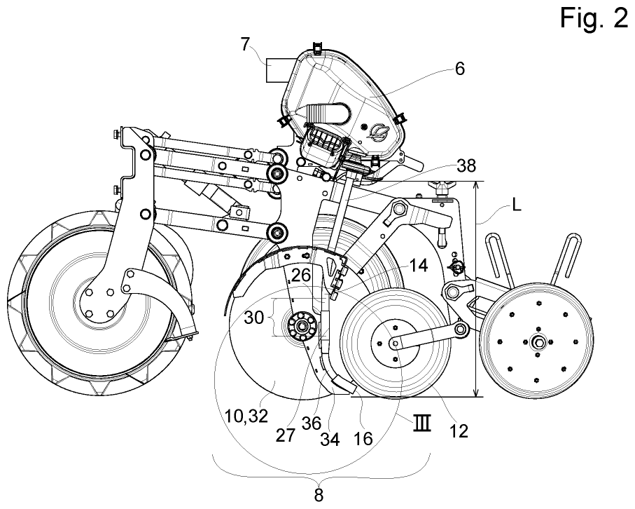

FIG. 2: a lateral view of a conveying line with a telescopable section, through which the length of the conveying line between the seed separating device and the drill unit is variable,

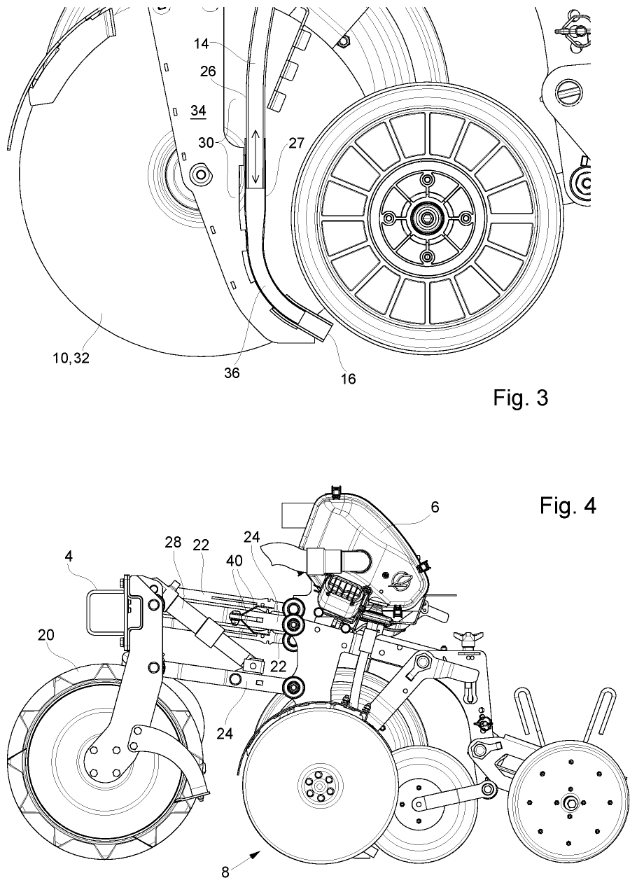

FIG. 3: an enlarged view of the circle III from FIG. 2 of a conveying line with a telescopable section, and

FIG. 4: a partly exposed lateral view of the moveable articulation of seed separating device and drill unit.

FIG. 1 shows a perspective view of a sowing machine 2 from obliquely from the back. The sowing machine 2 has a machine frame 4, to which multiple seed separating devices 6 are tied, which are each assigned to a drill unit 8. The drill units 8 consist at least of a furrow opener 10, a pressure element 12 and a conveying line 14, which conducts the seed grains separated in the seed separating device 6 out of the dispensing opening 16 into the sowing furrow. In the shown exemplary embodiment, the furrow opener 10 consists of double disc coulters 32, which are held at an angled position V-shaped relative to one another and on their lower side dip into the field ground in order to open a sowing furrow there. The furrow openers 10 can be connected to a depth guiding device 18 which, in the exemplary embodiment, consists of a wheel which for scanning the ground contour rolls laterally next to the sowing furrow over the field ground. In the shown example, a furrow opener 10 each is assigned to a depth guiding device 18 on both sides. In addition, packer rollers 20 or other units can be arranged in front of the furrow openers 10 which prepare the ground for the sowing and, if applicable, introduce fertiliser in the ground before the seed grains are placed in the sowing furrow. In the present example, ground grooves are pre-shaped and pre-compacted by the rings of the packer rollers 20, in which the furrow openers 10 form the final furrow shape for seed placement.

The seed separating device 6 is connected to the machine frame 4 via link arms 22, while the drill unit 8 with the furrow opener 10 and the pressure element 12 is connected via link arms 24 to the machine frame 4. The up and down movements of the furrow opener 10 can be dampened by the energy store 28. The seed separating device 6 and the drill unit 8 with the furrow opener 10 and the pressure element 12 are thus moveable in the vertical direction independently of one another so that the conveying line 14 has to bridge different size distances with the length L when the dispensing opening 16 is to convey the seed grains onto a point that remains at least approximately constant before, at or on the pressure element 12.

The seed separating device 6 is provided with an inlet opening 7 for supplying seeds and/or establishing a pneumatic pressure gradient. By means of a blower or compressor, which is not shown, a pressure gradient for the grain separation and supporting of the transport of the seed grains is generated.

FIG. 2 shows a lateral view of a conveying line 14 with a telescopable section 30, where the tube sections 26 dip into one another in order to thereby adapt the length L of the conveying line 14 between the seed separating device 6 and the drill unit 8 to the current requirement.

The telescopable section 30 is situated in the lower half of the conveying line 14, which extends from the seed separating device 6 as far as to the dispensing opening 16 and assumes the length L. Seen from the lateral view of the sowing machine 2, the same is situated in the shadow of or within the circle circumference of the disc coulter 32, which in the exemplary embodiment completely covers the telescopable section 30. The telescopable section 30 is fastened to a coulter skid 34, which in the exemplary embodiment is rigidly connected to the disc coulter 32. The outer one of the two disc coulters 32 is not shown for better clarity in the representation.

At its lower end, the conveying line 14 comprises a curved section 36 in which the seed grains are deflected from a conveying direction that is approximately directed vertically downwards into a direction directed opposite to the travelling direction towards the pressure element 12.

By means of the pneumatic pressure gradient, which is established by the inlet opening 7 in the seed separating device 6, a grain dispensation accelerated by an air flow out of the seed separating device 6 into the conveying line 14 is created.

In FIG. 3, it is clearly noticeable in the sectional view of the conveying line 14 in the region of the telescopable section 30 that the tube sections 26, 27 in the section 30 are formed so as to be moveable into one another in the conveying line 40 in the direction of the double arrow in that the tube ends of the tube section 26, 27 are dipped into one another by different depths, as happens to be required for the respective length L of the conveying line 14. Here, the lower tube section 27 is designed so that it simultaneously co-forms also the curved section 36. As already described in FIGS. 1 and 2, FIG. 4 shows the two link arms 24 which in the vertical direction are pivotably arranged on the frame 4 and guide the drill unit 8 relative to the frame 4. With an energy store 28, here embodied as hydraulic cylinder, the drill unit can be subjected to a vertical force in order to ensure an improved furrow formation. Independently of the drill unit 8, the seed separating device 6 is likewise pivotably fastened to the frame 4 in the vertical direction via two link arms 22. Between at least one link arm 22 of the seed separating device 6 and a link arm 24 of the drill unit 8, one or more spring/damper elements 40 are arranged, which cushion and/or dampen oscillations which occur during ground contact of the drill unit 8 in the direction of the seed separating device 6. Likewise, one or more spring/damper elements 40 can also be arranged directly between the seed separating device 6 and the drill unit 8 alternatively or additionally to the shown embodiment. Here, two leaf springs as spring/damper elements 40 are fastened to one of the two link arms 24 and slide on a stop which is assigned to the respective link arm 22 along the link arm 24 upon a relative movement of the link arm 22 and accordingly deform in accordance with the relative movement. Through the deformation, a corresponding spring force is generated which acts on the link arm. The sliding movement brings about a damping component. By way of a respective spring preload or spring rate, the force ratios between the two link arms 22 and 24 can be influenced. Instead of leaf springs, further bending or spiral springs as well as hydraulically and/or pneumatically acting springs/damper elements can be used.

The invention is not restricted to the above exemplary embodiments. The person skilled in the art has no difficulties modifying the exemplary embodiments in a manner deemed appropriate by the said person skilled in the art in order to adapt these to a specific application case.

### LIST OF REFERENCE NUMBERS

2 Sowing machine
4 Machine frame
6 Seed separating device
7. Inlet opening
8 Drill unit
10 Furrow opener
12 Pressure element
14 Conveying line
16 Dispensing opening
18 Depth guiding device
20 Packer roller
22 Link arm (pressure element)
24 Link arm (furrow opener)
26 Tube section, telescopic tube
27 Tube section, telescopic tube
28 Energy store
30 Telescopable section
32 Disc coulter
34 Coulter skid
36 Curved section
38 Elastic section
40 Spring and damper element

1. An agricultural sowing machine (2) having a machine frame (4) and a plurality of drill units (8) moveably arranged next to one another on the machine frame (4) and seed separating devices (6), wherein the drill units (8) comprise at least one furrow opener (10), a conveying line (14) for conveying the seeds from the seed separating device (6) to a placement zone with a dispensing opening (16) arranged near the ground and a pressure element (12), the at least one furrow opener (10), the dispensing opening (16) and the pressure element (12) being arranged in this working sequence relative to one another in the drill unit (8), the seed separating device (6), without a mechanically rigid connection to a component of a drill unit (8), is moveably connected to the machine frame (4), and the conveying line (14) is composed of tube sections (26, 27), which are formed in at least one section (30) so as to be telescopically moveable into one another, characterised in that the section (30) of the telescopic tubes (26, 27) is situated in the lower half of the conveying line (14).

2. The sowing machine (2) according to claim 1, characterised in that the furrow opener (10) is designed as one or two disc coulters (32) and the section (30) of the telescopic tubes (26, 27) is situated, from the lateral view of the sowing machine (2), completely within the circular circumference of the disc coulter or disc coulters (32) or partially protrudes over these.

3. The sowing machine (2) according to claim 1, characterised in that on the outside of the conveying line (14) in the region of the section (30) of the telescopic tubes (26, 27) a sleeve sealing the telescopic connection is mounted.

4. The sowing machine (2) according to claim 1, characterised in that the section (30) comprises at least one inner (26) and outer part (27) of the telescopic tubes (26, 27), wherein the outer part (27), in the conveying direction of the conveying line (14), is arranged or plugged on behind or below the inner part (26).

5. The sowing machine (2) according to claim 1, characterised in that the part of the conveying line (14) comprising the section (30) of the telescopic tubes (26, 27) is connected to a coulter skid (34).

6. The sowing machine (2) according to claim 5, characterised in that the coulter skid (34) is moveably connected to the machine frame (4) so that the same can perform relative movements relative to the same.

7. The sowing machine (2) according to claim 1, characterised in that a section (36) of the conveying line (14) following a curved course adjoins the section (30) of the telescopic tubes (26).

8. The sowing machine (2) according to claim 1, characterised in that a change in length of the conveying line (14) furthermore results from a section (38) of the conveying line (14) that is produced from an elastic material, wherein the inner surface of the section (38) produced from an elastic material is in the form of a hose.

9. The sowing machine (2) according to claim 8, characterised in that the inner surface of the section (38) produced from an elastic material is not interrupted by material folds and/or corrugations.

10. The sowing machine (2) according to claim 8, characterised in that the section (38) produced from an elastic material has, over its length, a cross-sectional shape of the interior that remains at least approximately the same.

11. The sowing machine (2) according to claim 8, characterised in that the section (38) produced from an elastic material has, with its cross-sectional shape of the interior, an almost approximately or exactly offset-free transition to the neighbouring regions of the conveying line (14).

12. The sowing machine (2) according to claim 8, characterised in that the section (38) produced from an elastic material consists at least partially of a fabric material.

13. The sowing machine (2) according to claim 1, characterised in that the conveying line (14) is formed flexible at least in a section (36).

14. The sowing machine (2) according to claim 13, characterised in that the conveying line (14) is designed so as to be flexible in a section (30, 36) within a bending plane which stands parallel to a movement plane of the drill unit (8) to the machine frame (4).

15. The sowing machine (2) according to claim 8, characterised in that the section (38) of the conveying line (14) produced from an elastic material is subjected, in the installed state, to a preload in a stretch direction.

16. The sowing machine (2) according to claim 1, characterised in that the seed separating device (6) has at least one separating element which meters or separates the seeds by means of a pneumatic pressure gradient.

17. The sowing machine (2) according to claim 8, characterised in that the conveying line (14) in its course comprises elevations and/or recesses on the inner surfaces, which generate turbulent flows in the wall region in the air flow.

18. The sowing machine (2) according to claim 8, characterised in that the conveying line (14) on its half facing the ground is connected to the moveable mounting of the furrow opener (10).

19. The sowing machine (2) according to claim 8, characterised in that the seed separating device (6) is coupled to the drill unit (8) via a spring and/or damper element (40).

20. The sowing machine (2) according to claim 8, characterised in that the seed separating device (6) is coupled to the machine frame (4) via a spring and damper element (40).
